(19) United States
(12) Patent Application Publication
(10) Pub. No.: US 2006/0224458 A1
(43) Pub. Date: Oct. 5, 2006

(54) Menu post, wireless headset and telephone system interface controller

(75) Inventor: Paul Y. Liu, Lisle, IL (US)

Correspondence Address: DELLETT & WALTERS, P. O. BOX 82788, PORTLAND, OR, 97282-0788, US

(73) Assignee: American Communication & Networks Corp.

(21) Appl. No.: 11/077,625

(22) Filed: Mar. 10, 2005

(51) Int. Cl. G06Q 30/00; G06Q 50/00

(52) U.S. Cl. 705/15

(57) ABSTRACT

The present invention relates to an interface controller that integrates an existing telecommunication device, a door answering system and a headset base all set up in a restaurant. Based on the operation modes performed by the interface controller, a remote order center can talk to the customers in the restaurant through the telephone system. In another aspect, if there is no response received from the remote order center, the customers can directly have service from local personnel of the restaurant.

### BACKGROUND OF THE INVENTION

1. Field of the Invention

The invention relates to an interface controller, and more particularly to an interface controller for integrating a menu post, wireless headset and telephone system.

2. Related Art

To provide service to patrons, sit-down types of restaurants have required personnel such as a host (or hostess) to seat the patrons and attend to their general needs. A waiter/waitress takes the patron's menu selection and communicates that selection to the kitchen and delivers the prepared selection to the table. A cashier receives payment for the food and service and bus boys and other personnel assist the waiter in cleaning-up.

The fast-food industry is also labor intensive. In a typical example, a cashier takes the patron's order, rings it up in the cash register, communicates the order to the kitchen, and receives cash payment. This process is inefficient since the restaurant must be staffed with sufficient cashiers and cooks to properly fill the orders.

Attempts have been made to increase the efficiency of restaurants. For example, in those fast-food restaurants having a drive-through service, the patron can drive past a menu board and verbally makes a selection, personnel by the way of a drive-through then deals with that selection.

A wireless communication system including a wireless base station in association with wireless headsets is widely applied in those fast-food restaurants. The service personnel in the restaurant may wear the wireless headset to directly communicate with each other or to the kitchen. Aside from the wireless communication system, a door answering system is also used in the drive-through service of the fast-restaurants. The door answering system allows the patron to directly speak to service personnel while ordering food without needing to leave the car. However, since each of the above mentioned systems is operated independently, an apparatus with capability of integrating those systems to further improve their efficiency would be profitable.

### SUMMARY OF THE INVENTION

An objective of the present invention is to propose an interface controller that integrates an existing menu post, wireless headset and telephone system in a restaurant. Based on the operation mode performed by the interface controller, a remote order center can acquire precedence to talk to the customers in the restaurant through the telephone system. Otherwise, in the case that the order center gives no response, the customers are directly served by local service personnel of the restaurant.

Further advantages, features and details of the present invention will be elucidated on the basis of the following description of a preferred embodiment thereof, with reference to the annexed figure showing a circuit diagram thereof.

### BRIEF DESCRIPTION OF THE DRAWINGS

FIG. 1 is an operational block diagram of an interface controller being connected to a wireless headset base, a door answering system and a remote IP-PBX.

FIG. 2 is a block diagram of the interface controller of FIG. 1 in accordance with the present invention.

FIG. 3 is a detailed circuit diagram of the interface controller in accordance with the present invention.

### DETAILED DESCRIPTION OF THE PREFERRED EMBODIMENT

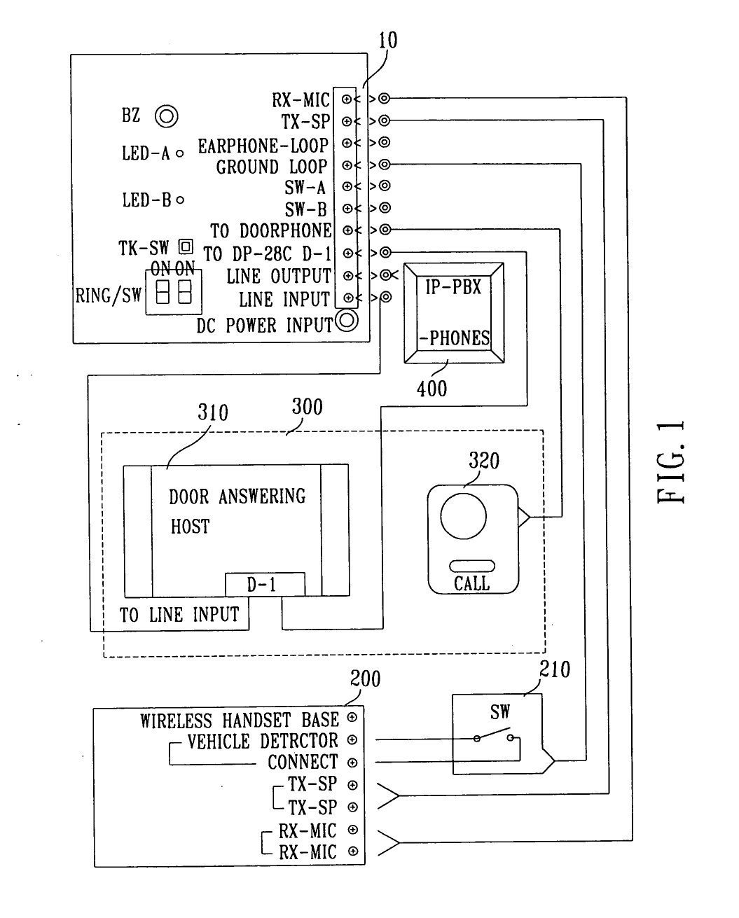

With reference to FIG. 1, the present invention is to provide an interface controller (10) that integrates an existing wireless headset base (200), a door answering system (300) as well as an IP-PBX (private branch exchange) (400). To more clearly explain the embodiment, the interface controller (10) together with all above mentioned equipment (200), (300) and (400) are applied in a fast-food restaurant with drive-through service to more efficiently improve the food-ordering system. With regards to the management of well known fast-food establishments, such as McDonald™ and Burger King™, an order center may be set up to manage or monitor multiple local stores. The order center is able to monitor and communicate with its local stores over the Internet communication by the IP-PBX (400) in real time. In a case that a sudden matter occurs in one of those local stores, the order center can immediately take over the unexpected situation and give proper response back.

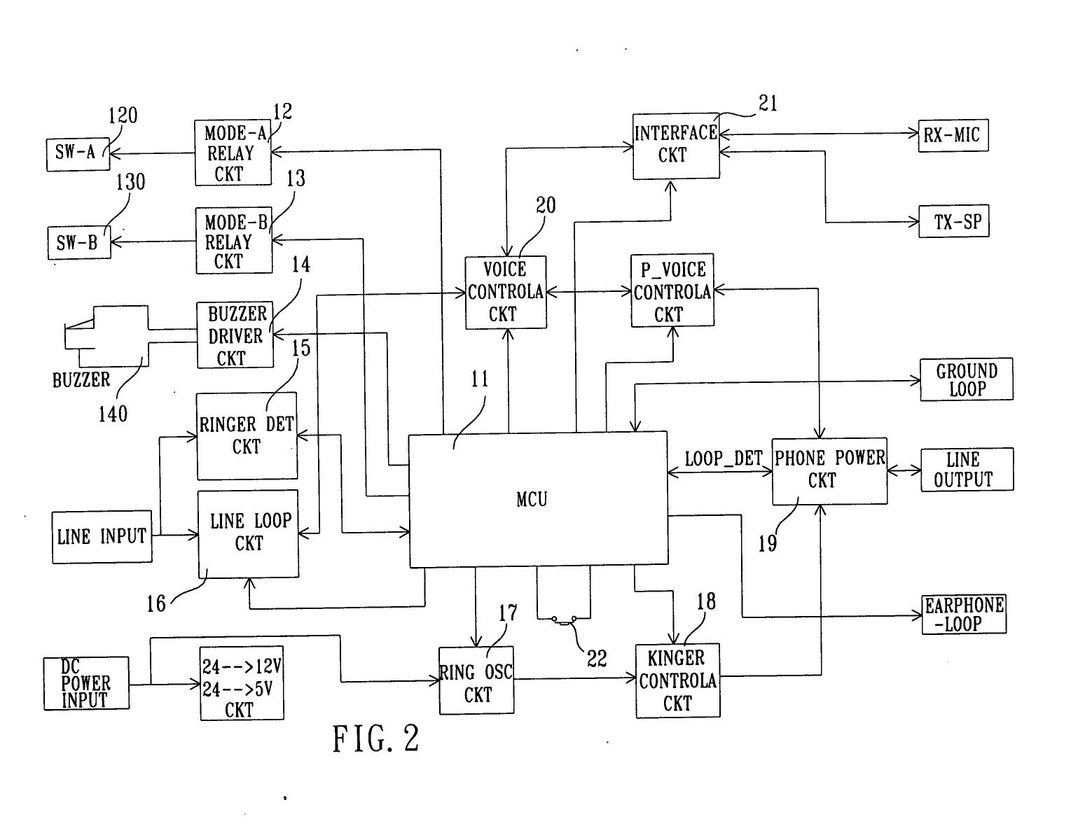

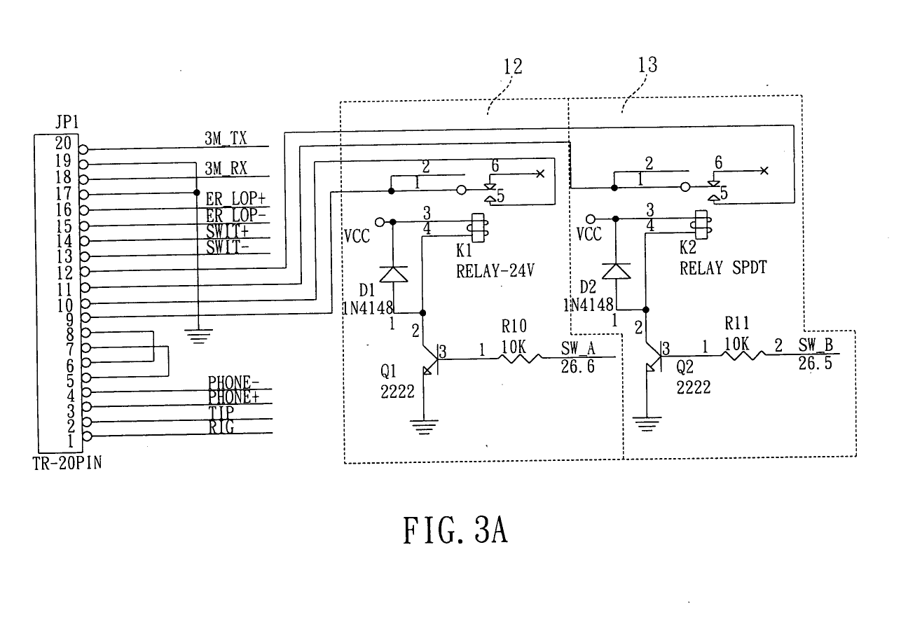

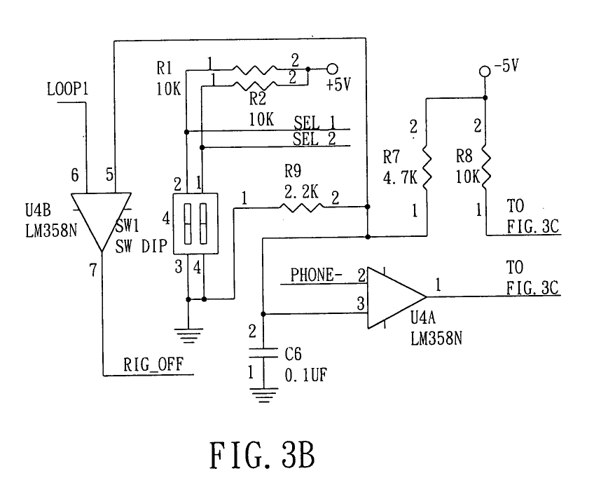

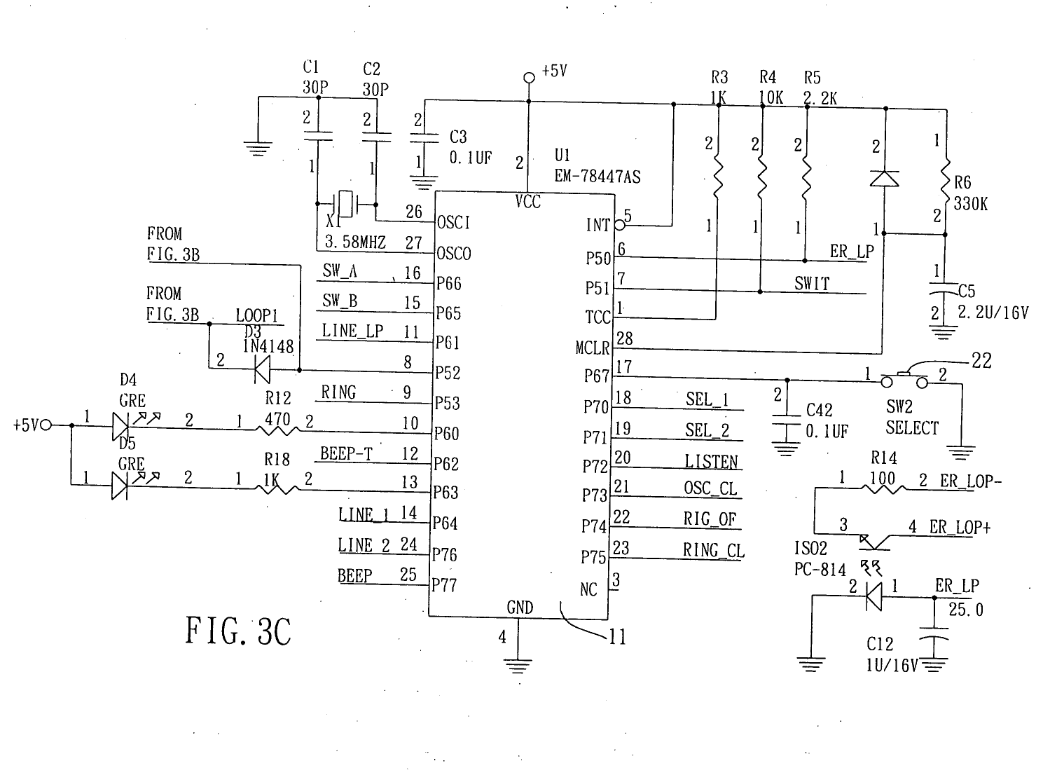

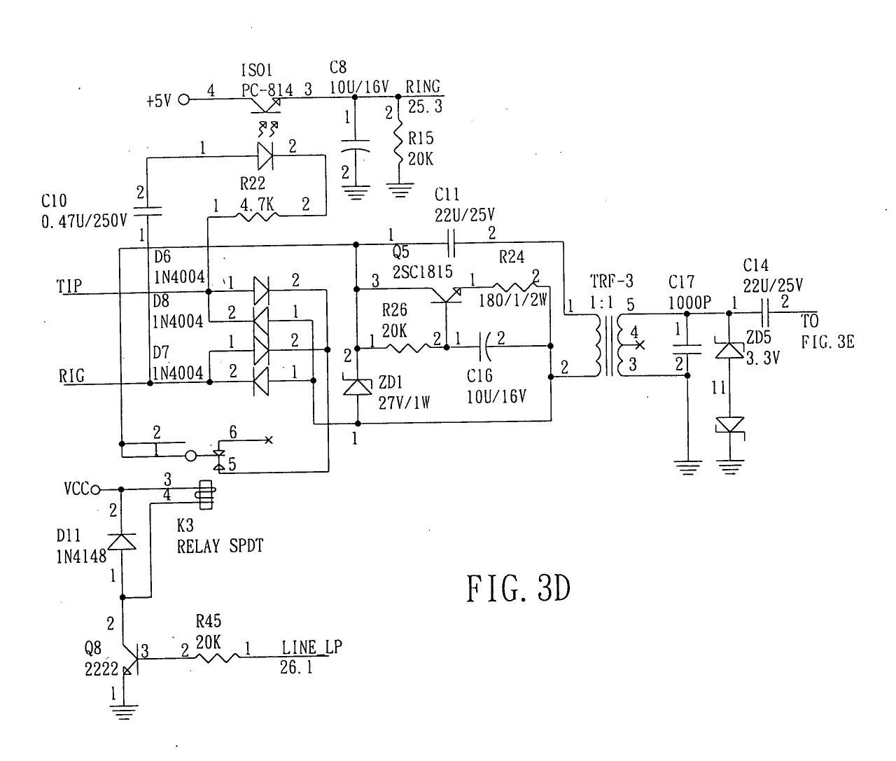

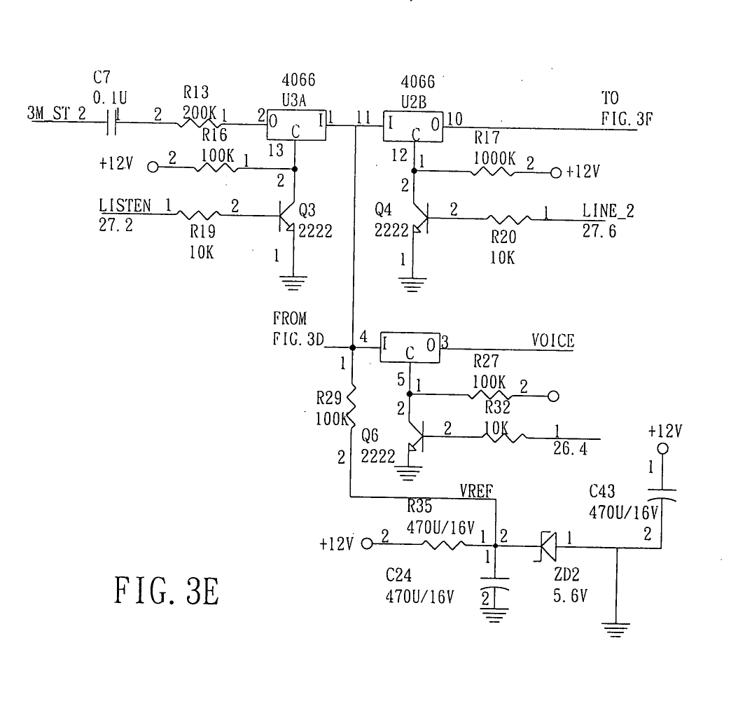

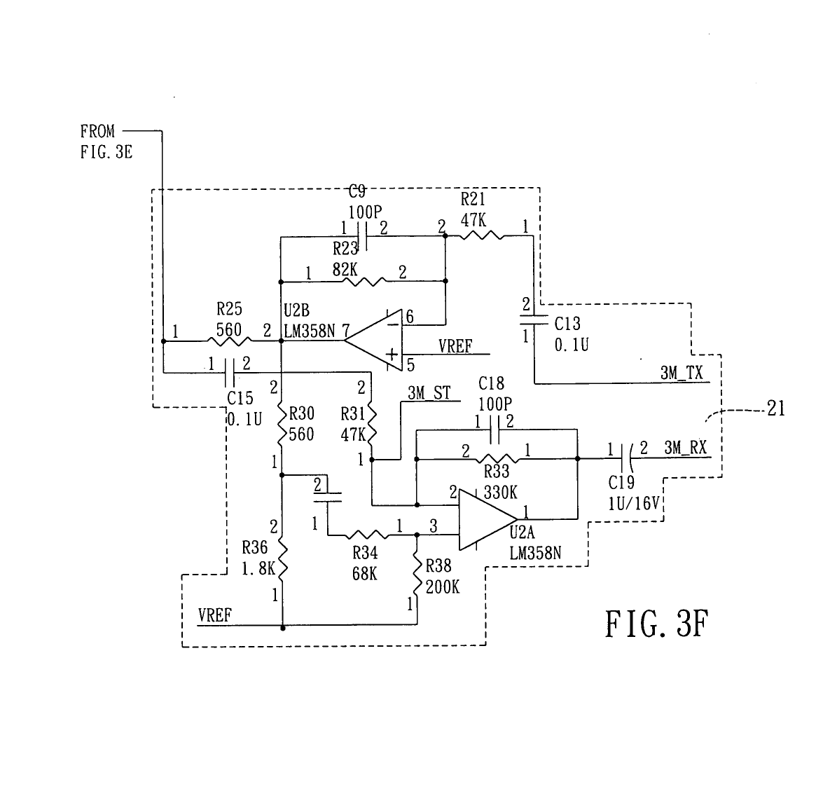

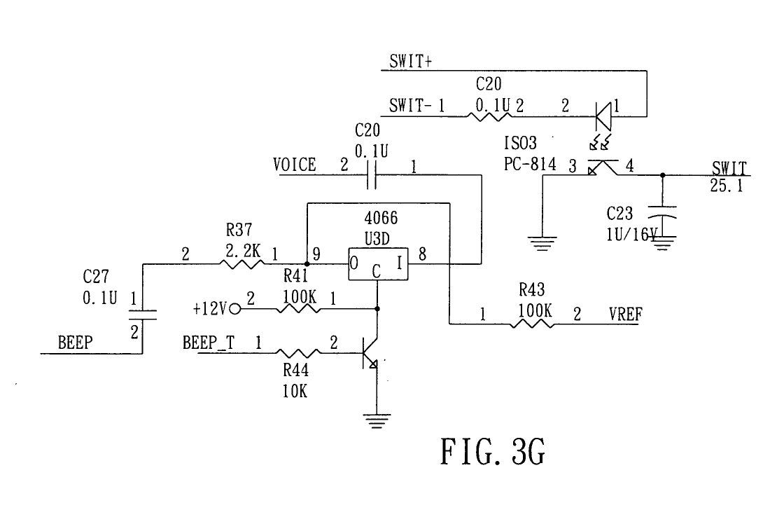

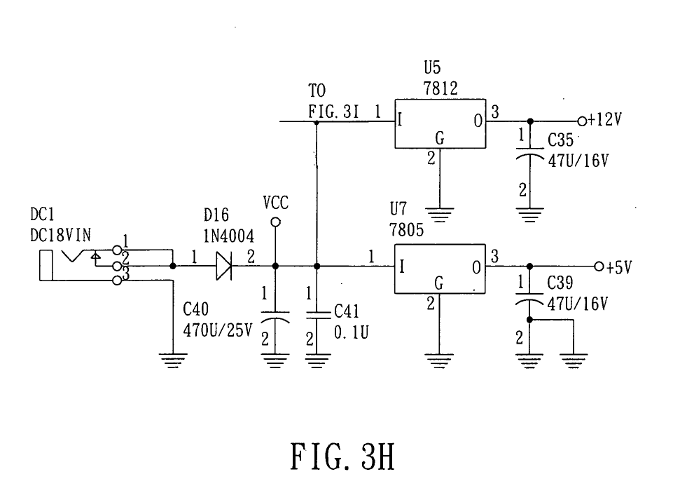

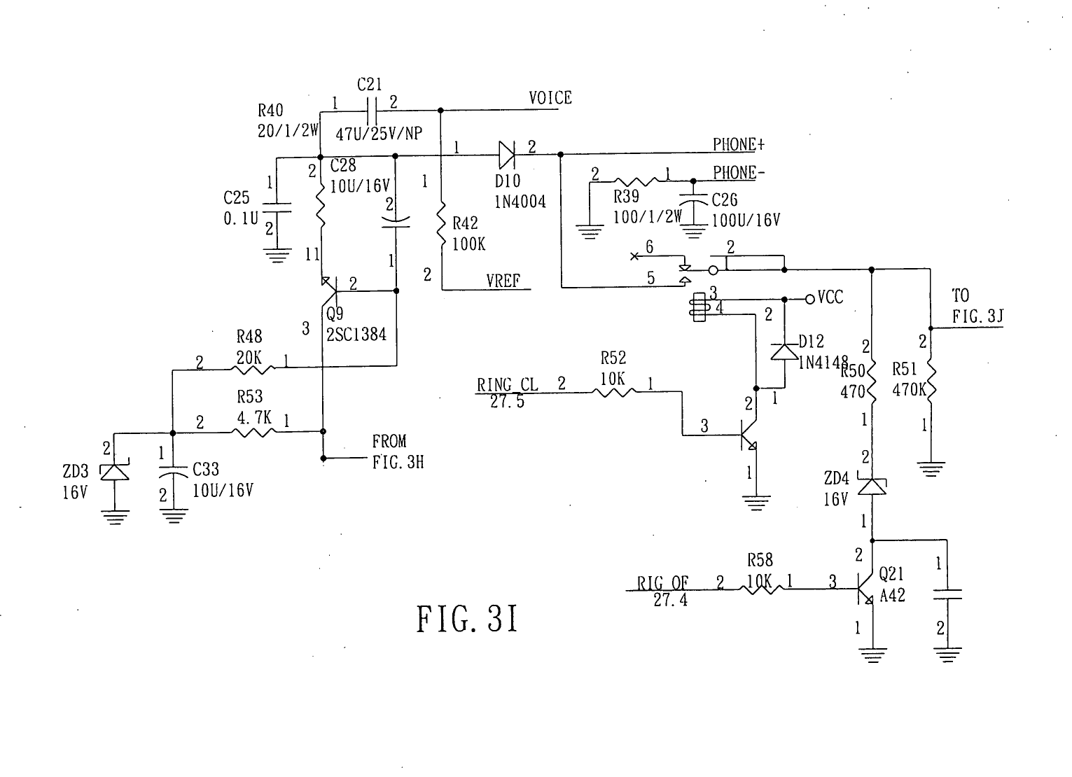

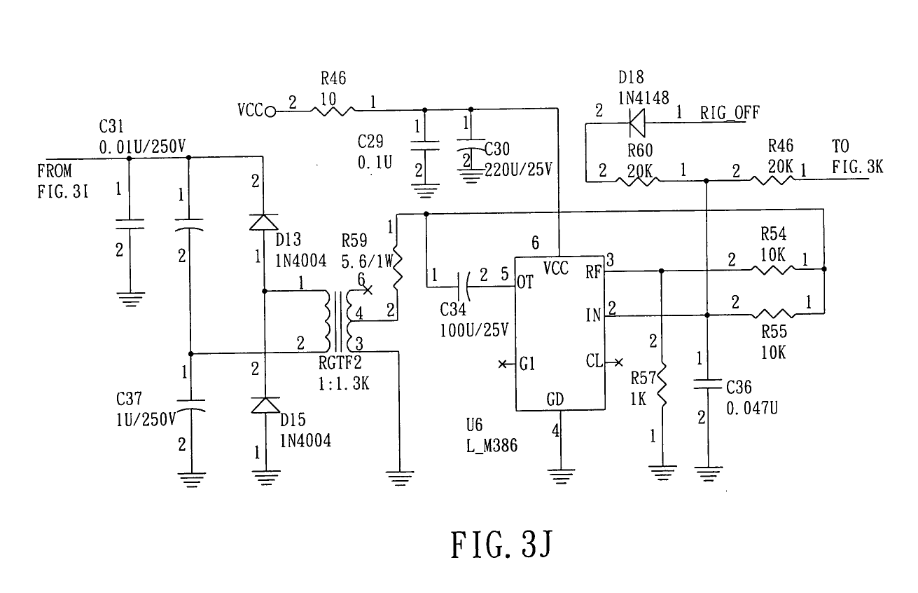

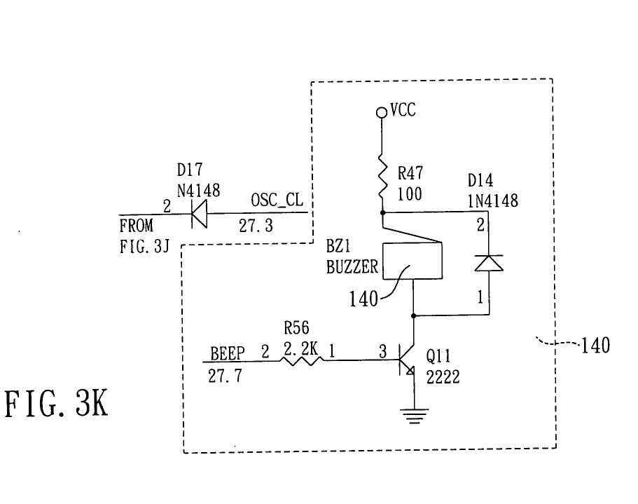

With reference to FIGS. 1 and 2, the interface controller (10) is preferably formed as a circuit board with an interface socket mounted thereon. The interface socket has a plurality of terminals for electrical connection to the equipment (200), (300) and (400). The terminals on the interface socket are respectively denominated with Rx-Mic, Tx-Sp, Earphone-Loop, Ground Loop, SW-A, SW-B, To Doorphone, To Doorphone answering host, Line Output, Line Input and DC power Input.

The IP-PBX (400) or any telephone is coupled to the “Line Output” terminal thereby communicating with the remote order center.

The door answering system (300) consists of a door answering host (310) and one or more intercoms (320). The door answering host (310) is linked to the “Line Input” while the intercom (320) is connected to “To Doorphone” terminals.

The wireless headset base (40) connects to the “Ground Loop” terminal through a vehicle sensor (210). The vehicle sensor (210) is mounted on or near a drive-through path along which a motorist operates a vehicle through the restaurant to order foodstuff. The vehicle sensor (210) can be a pressure-based sensor mounted on the path to detect movement of a vehicle.

The interface controller (10) comprises an MCU (microprocessor control unit) (11) connecting to a mode-A relay circuit (12), a mode-B relay circuit (13), a buzzer driver circuit (14), a ringer detecting circuit (15), a line loop circuit (16), a ring oscillating circuit (17), a ringer controller circuit (18), a phone power circuit (19), a voice control circuit (20), an interface circuit (21) and a mode switch (22).

The mode-A relay circuit (12) and the mode-B relay circuit (13) respectively connect to a mode-A output terminal (120) and a mode-B output terminal (130), wherein the two terminals (120) (130) respectively act as the “SW-A” and “SW-B” terminals of the interface socket.

The buzzer control circuit (14) connects to a buzzer (140) to generate warning sounds.

The ringer detecting circuit (15) and the line loop circuit (16) are connected to the “To Doorphone”, “To Doorphone AnsweringHost” and “Line Input” terminals of the interface socket.

A DC power is supplied to an operating voltage to the ring oscillating circuit (17) through the “DC power Input” terminal and further converted to different voltage levels such as 12 volts or 5 volts delivered to other circuits in the interface controller (10).

The phone power circuit (19) is further coupled to the ringer controller circuit (18), a P_voice controller circuit (190) and the “Line output” terminal on the interface socket.

Aside from the MCU (11), the interface circuit (21) also connects to the voice controller circuit (20) and the “Rx-Mic” and “Tx-Sp” terminals.

With regards to the “Ground Loop” and “Earphone Loop” terminals of the interface socket, both are directly connected to the MCU (11).

The interface controller (10) is operated in either an A mode or a B mode. Every time the interface controller (10) is powered on, it automatically enters the predetermined A-mode in which if the motorist drives the vehicle into the drive-though path and actuates the intercom (320), a ring signal is generated and the buzzer (140) can be activated. At the same time, a switch in the mode-A relay circuit (12) turns to a conductive status thus generating a signal at the “SW-A” terminal for other applications. If the IP-PBX (400) recognizes and responds to the ring signal, communication to the customer is established from the remote order center via the IP-PBX (400) and the door answering system (300). In the aspect of the local restaurant using the wireless headset base (200), the service personnel can not use their headsets to talk to the customers who are in communication with the order center, but still can listen to their conversations.

Otherwise, the time limit is passed and there is still no answer received from the IP-PBX (400)(the order center), the interface controller (10) will automatically enter the B-mode. Similarly, a switch in the mode-B relay circuit (13) moves to a conductive status and generates a signal at the “SW-B” terminal. Furthermore, the service personnel of the local restaurant can directly talk with the customers through the door answering system (300) as well as the wireless headset base (200). Although the interface controller (10) can automatically change its operation modes, it is noted that users still can directly alter mode from A to B just by pressing the mode switch (22).

The present invention is not however limited to the above described preferred embodiment thereof, the rights sought are defined by the following claims, within the scope of which many modifications can be envisaged.

What is claimed is:

1. An interface controller (10) connecting to a telecommunication device, a door answering system and a headset base, the interface controller (10) comprising:
an MCU (microprocessor control unit) (11) with terminals connected the headset base that generates a trigger signal in response to a detected movement of a vehicle, wherein a ring signal is generated and sent to an output terminal of the MCU (11) to which the telecommunication device connects;
if a response is received from the telecommunication device within a determined time, the interface controller (10) enters a first mode in which the telecommunication device is allowed to connect to the door answering system; otherwise, the interface controller (10) enters a second mode to connect the headset base to the door answering system.

2. The interface controller (10) as claimed in claim 1, the MCU (11) further connects to a mode-A relay circuit (12), a mode-B relay circuit (13), a buzzer driver circuit (14), a ringer detecting circuit (15), a line loop circuit (16), a ring oscillating circuit (17), a ringer controller circuit (18), a phone power circuit (19), a voice control circuit (20), an interface circuit (21) and a mode switch (22).

3. The interface controller (10) as claimed in claim 2,
Mr. Chang, please explain the function of each circuit mentioned in claim 2.
